(19) United States
(12) Patent Application Publication
(10) Pub. No.: US 2019/0205830 A1
(43) Pub. Date: Jul. 4, 2019

(54) SYSTEM AND METHOD FOR KIOSK STATION TO AUTONOMOUSLY ACCEPT OR DECLINE PACKAGE DELIVERY BASED ON CONFIDENCE LEVEL

(71) Applicant: Walmart Apollo, LLC, Bentonville, AR (US)

(72) Inventors: John J. O'BRIEN, Farmington, AR (US); Donald R. HIGH, Noel, MO (US); Brian MCHALE, Oldham (GB); David WINKLE, Bella Vista, AR (US); Samantha M. MANGOSING, Bella Vista, AR (US); Robert CANTRELL, Herndon, VA (US)

(73) Assignee: Walmart Apollo, LLC, Bentonville, AR (US)

(21) Appl. No.: 16/224,271

(22) Filed: Dec. 18, 2018

Related U.S. Application Data
(60) Provisional application No. 62/611,749, filed on Dec. 29, 2017.

(51) Int. Cl. G06Q 10/08; H04L 9/06

(52) U.S. Cl. CPC G06Q 10/0835; G06Q 10/0836; H04L 2209/38; H04L 9/0643; G06Q 10/0832

(57) ABSTRACT

Systems and methods for a kiosk station to autonomously accept or decline a package delivery from an autonomous vehicle based on a confidence level is provided. An example system includes the kiosk station configured to: determine its capabilities for accepting the package delivery; convert the capabilities into a binary format; and transmit the binary format to a cloud-based database management unit. The example system also include the autonomous vehicle configured to: generate a deliver task request for the package delivery to be sent to the kiosk station; convert the delivery task request to a binary format; and transmit the binary format to the cloud-based database management unit. The example system further include the cloud-based database management unit configured to: compare the binary format of the kiosk station's capabilities with the binary format of the delivery task request; and generate the confidence level based on the comparison.

### CROSS REFERENCE TO RELATED APPLICATION

This patent application claims the benefit of U.S. Provisional Application No. 62/611,749, filed Dec. 29, 2017, content of which is incorporated by reference herein.

### BACKGROUND

### 1. Technical Field

The present disclosure relates to package deliveries by autonomous vehicles, and more specifically to systems and methods for a kiosk station to autonomously accept or decline a package delivery based on a confidence level.

### 2. Introduction

As the Internet of Things (IoT) continues to evolve, communications between devices continue to evolve. For example, autonomous vehicles (e.g., drones and unmanned aerial vehicles (UAV)) are being designed to use mesh networks for communications between vehicles, such that every vehicle is aware of the speed, direction, braking, etc., of the other vehicles, allowing unprecedented coordination. Similarly, with regarding to package deliveries by autonomous vehicles such as drones, the autonomous vehicles and kiosks receiving the package deliveries can communicate with one another to ensure the deliveries of packages.

However, while the currently available communications between devices or vehicles allow for more informed devices, they do not necessarily improve other aspects of the devices. For example, having more informed devices does not, by itself, provide for collaborative computing, collaboratively storing data in databases, and collaboratively sharing and updating data between those informed devices, for example drones and kiosks, which may affect timely and accurately deliveries and acceptance of packages.

### SUMMARY

A system configured as disclosed herein can include a kiosk station. The kiosk station is configured to: determine its capabilities for accepting the package delivery; convert the capabilities into a binary format; and transmit the binary format to a cloud-based database management unit. The system also include an autonomous vehicle. The autonomous vehicle configured to: generate a deliver task request for the package delivery to be sent to the kiosk station; convert the delivery task request to a binary format; and transmit the binary format to the cloud-based database management unit. The cloud-based database management unit configured to: compare the binary format of the kiosk station's capabilities with the binary format of the delivery task request; generate the confidence level based on the comparison; and distribute the confidence level to the kiosk station and the autonomous vehicle. The kiosk is further configured to determine whether to accept or decline the package delivery based on the confidence level. The autonomous vehicle is further configured to determine whether to perform the package delivery based on the confidence level.

A method for performing concepts disclosed herein can include: determining capabilities of a kiosk station for accepting a package delivery; converting the capabilities into a binary format; and receiving a deliver task request for the package delivery from au autonomous vehicle; converting the delivery task request to a binary format of the delivery task request; comparing the binary format of the kiosk station's capabilities with the binary format of the delivery task request; generating the confidence level based on the comparison; and determining whether to accept or decline the package delivery based on the confidence level.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates an exemplary mesh network between devices;

FIG. 2 illustrates an exemplary blockchain based on interactions between devices;

FIG. 3 illustrates an exemplary delivery task request from an autonomous vehicle;

FIG. 4 illustrates exemplary capabilities of a kiosk station;

FIG. 5 illustrates an exemplary process of generating confidence levels;

FIG. 6 illustrates an exemplary method embodiment; and

FIG. 7 illustrates an exemplary computer system.

### DETAILED DESCRIPTION

As described above, kiosk stations for autonomous vehicle package delivery are currently unable to communicate an ability to accept or decline a delivery. Systems and methods according to this disclosure can allow a kiosk station to automatically accept or decline a package delivery, for example, by an autonomous vehicle (e.g., a drone or a UAV), based on a confidence level. The confidence level may be converted into a binary code for seamless communications between the kiosk station and the autonomous vehicle. Specifically, a confidence level is employed to determine whether a package could be accepted by a kiosk. This disclosure provides systems and methods for an autonomous vehicle (e.g., UAV or drone) to communicate its package size, weight, cold chain requirements, etc. to the kiosk so that the kiosk can determine if it has the capacity to accept the package. The confidence level may allow a particular criterion to fail, but may allow for acceptance of the package, provided other criteria allow for passage.

The autonomous vehicle communicates with the kiosk and provides package size and delivery requirements. Exemplary delivery requirements or rules may include maintaining a distance to small children, pets, etc. in the area of the kiosk. The requirements may also include weather (rain may preclude a delivery, but may also add a time delay to allow for a delivery to be completed). The disclosed system may also indicate that a front door of a building is unacceptable for a particular delivery but may accept a delivery on a back porch of the building (i.e., a secondary delivery location). The kiosk can communicate with the autonomous vehicle to broadcast its capabilities of accepting a package with respect to the requirements.

The package delivery information and requirements from the autonomous vehicle may be converted into a binary format. Also the capabilities of the kiosk may be converted to a binary format. Confidence levels can be generated by comparing the binary format of the package delivery information and requirements with the binary format of the capabilities of the kiosk. The confidence levels may be designated as a positive number, a zero, or a negative number. For example, a positive number may be used to indicate that the capabilities of the kiosk exceed the requirements of the package delivery; a zero may be used to indicate that the capabilities of the kiosk just meet the requirements of the package delivery; and a negative number may be used to indicate that the capabilities of the kiosk does not meet the requirements of the package delivery. An example of the confidence level can be −1 indicating that the kiosk is unable to accept the package delivery; 0 indicating that the kiosk can accept the package; and +1 indicating that the kiosk can accept the package meeting many of the delivery requirements.

In some embodiments, the autonomous vehicle may inform the kiosk of its own requirements, for example, charging its battery at a kiosk. For instance, the kiosk may not have the capability to charge battery of a particular vehicle. In that case, the confidence level assigned to the kiosk may be low for that feature of charging a battery.

In some embodiments, the systems and methods disclosed herein of a confidence level may also be employed for other decision-making use-cases, such as identity, point of origin, or source, which may implicate security and package confidence.

As an autonomous vehicle plans to deliver a package to a kiosk station, the autonomous vehicle may need to send a delivery task request to the kiosk station to inquiry on the capabilities of the kiosk for acceptance of the package. The delivery task request may include requirements for the package to be delivered. The requirements may include, but are not limited to, at least one of: the number of packages to be delivered (i.e., package transfer unit), length of the package, width of the package, weight of the package, height of the package, and a temperature range for storing the package. Also, the kiosk station may determine its capabilities for accepting the package delivery, and send the capabilities to the autonomous vehicle.

In some embodiments, the delivery task request and capabilities for accepting the package delivery can, for example, be broadcast through a mesh network between devices (e.g., autonomous vehicles, kiosks, and cloud-based database management unit), until all the devices within a group, or within a radius of the initial requesting device, have received the request. As devices receive the request, responses to the request are generated and sent back to the requesting device, each response providing an answer as to the ability of each respective device to fulfill the request. The requesting device receives the responses, aggregates and analyzes the responses, and determines how to transition information and resources to deliver or accept a package based on the responses. In some cases, this can require transferring information from the requesting device to another device through the mesh network. In addition, the capabilities for accepting a package may vary for different delivery task requests from the autonomous vehicle. That is, the capabilities for accepting a package by the kiosk may dynamically change. For example, a locker of the kiosk station that is available may be unavailable up to 10 minutes prior to a package delivery. Similarly, the delivery task request may change. For example, the temperature of the package may rise significantly prior to the delivery and requires the kiosk to quickly cool down the package to a preferred temperature range upon delivery. These changes may be broadcast to the group through the mesh network.

In some cases, a peer-to-peer authentication may be required that allows online interactions directly between an autonomous vehicle and a kiosk station without going through one or more trusted intermediaries. Such a peer-to-peer network can timestamp actions (e.g., sending a delivery task request by the autonomous vehicle), hashing them into an ongoing chain of hash-based proof-of-work code to form a record that cannot be changed without redoing the proof-of-work. The longest chain distributed on the peer-to-peer network proves that the data must have existed at the time in order to get into the hash, thereby proving the sequence of events witnessed and that the integrity of the digitized document has been maintained. In an exemplary embodiment, the authentication may utilize one or more aspects of conventional blockchain. The authentication may allow any two or more willing parties (e.g., autonomous vehicles, kiosks, and cloud-based database management units) to employ the content (e.g. delivery task requests and capabilities of a kiosk), without the need to trust each other and without the need for a trusted third party.

In some configurations, communications between autonomous vehicles, kiosks, and cloud-based database management units can take the form of a blockchain, where each request and response made by devices can be added to the blockchain ledger. As any device takes an action (sending a request, sending a response to a request, sending capabilities of accepting a package), that information is added to the blockchain. More specifically, the request, response, or other action is hashed into the previous blockchain. This new, updated blockchain is then distributed to the other devices within the group.

The devices in the peer-to-peer network may be unmanned or autonomous vehicles, drones, robotics, communication devices, or any other electronic device. For example, in one configuration the devices sending a delivery task request may be an electronic device (e.g., a smartphone or a computing tablet) used by a user who drops off a package in a kiosk station, whereas in another configuration the devices may be autonomous vehicles, delivery drones, or smart home devices. In yet another configuration, the devices may be distinct types of devices, such as a drone and smart home devices communicating, making requests, and generating responses to those requests.

The information (e.g., delivery task requests, capabilities of a kiosk, and confidence level information) shared between devices (i.e., on the mesh network) is done in a peer-peer network of devices that is decentralized. That is, all devices have the potential for sharing and distributing information on package deliveries. This system can be authenticated, shared, and managed, by a block chain system for authentication and decentralization. For instance, if a delivery drone plans to deliver a package to a kiosk, the delivery drone can relay an initial block chain of information, as a request, to all other devices in the group. This request can contain package transfer unit (e.g., 1 package), length of the package, width of the package, weight of the package, height of the package, a temperature range for storing the package, time stamp, digital currency information, authentication information, etc. The request may also contain supplemental information, such as “is the kiosk located in an appropriate location?” (e.g., is it close enough for picking up the package?)

Other devices within the group will receive and authenticate the transmission, then may provide additional information to respond to the delivery task request. For example, the kiosk in the group may provide its capabilities for accepting the package, and the cloud-based database management unit in the group may further process and store the capabilities information and the delivery task request information. This in turn causes an update to the previous block within the block chain, which will contain the “slave” (second) device's updates with the original “master” initial block (the request). Thus, information is accurately shared between the devices with the necessary information, including updates, etc. As used herein, the cloud-based database management unit may include one or more computing devices on which a database management system may run.

By sharing the data and information between devices, the autonomous vehicles, the kiosks, and the cloud-based database management unit can communicate and coordinate dynamically to ensure delivering the package timely and accurately. The data and information may be stored in a distributed ledger using blockchain technology. For example, kiosks can have an active, ongoing communication with the cloud-based database management unit to store and update the information as to what the kiosks can take (i.e., capabilities of the kiosk). The kiosks may broadcast to other devices of the group the free space based on horizontal and vertical dimensions, as well as time, temperature, special handlings, authorization capability (e.g., liquor) that the kiosks can offer. Similarly, the autonomous vehicle may interact with the cloud-based database management unit to send and/or update the task delivery requests. By using such blockchain technology, an immutable trail can be created, and token could only be spent and reserved once—removes change of duplicity. The coordinates on the kiosk's location may also be communicated to the autonomous vehicle for delivery of the package. A time slot may be reserved for the kiosk to deliver the package. This time slot can also be a sort of authentication criteria. In some cases, a kiosk may embody a 3D printer such that a package can be printed and held until a customer gets it.

The information shared and transmitted between devices (such as delivery task requests, responding to requests of delivery task requests, confidence levels, authentication, and protocol sharing), can utilize blockchain or other authentication methods. Exemplary data which can be stored on a device (and transmitted/received between devices as required) can contain different categories of capabilities of kiosks including a maximum number of packages, a package height, a package length, a package width, and a package weight that the kiosk station can accept The exemplary data may also contain delivery task request requirements for the package to be delivered including at least one of: the number of package to be delivered, length of the package, width of the package, weight of the package, height of the package, and a temperature range for storing the package.

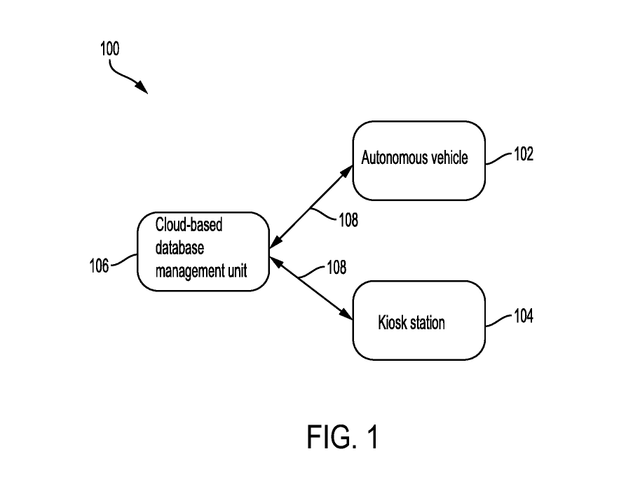

Various specific embodiments of the disclosure are described in detail below. While specific implementations are described, it should be understood that this is done for illustration purposes only. Other components and configurations may be used without parting from the spirit and scope of the disclosure, and can be implemented in combinations of the variations provided. These variations shall be described herein as the various embodiments are set forth. The disclosure now turns to FIG. 1.

FIG. 1 illustrates an exemplary mesh network 100 between an autonomous vehicle 102 that delivers packages to a kiosk station 104. Both the autonomous vehicle 102 and the kiosk station 104 communicate with a cloud-based database management unit 106. A mesh network such as that illustrated is a network where each node can relay data from and to other nodes within the network. While mesh networks can be constructed to operate in wired conditions, they are more prevalent in wireless configurations, where messages can be broadcast to other nearby nodes (i.e., not sent to a specific node, but rather all nodes within a given distance of the broadcasting node). When a receiving node is located outside the broadcast range of a transmitting node, intermediate nodes may be required to route the transmission to the receiving node. For example, as illustrated, node 102 can communicate 108 with node 106, and node 104 can communicate 108 with node 106. However, nodes 102 and 104 cannot communicate with each other. Because node 102 can only communicate with node 106, any communications 108 between node 102 and node 104 must route through node 106. Direct communication between the nodes is also possible.

The kiosk station 104 determines its ability or capabilities to accept a package. The kiosk station 104 may communicate its capabilities to the cloud-based database management unit 106. The kiosk station 104 may further convert its capabilities of accepting a package into a confidence level system. For example, +1 is used for exceptional ability to accept a package; 0 is used for acceptable ability to accept a package; and −1 is used for inability to accept a package. The kiosk station 104 may also convert any other supplemental information to add to the confidence level system in a binary format. For example, −1 indicates that the kiosk station 104 cannot accept a package based on maximum payload reached (e.g., 100 lbs.). The kiosk station 104 may further communicate such confidence levels to the cloud-based database management unit 106.

In some embodiments, the cloud-based database management unit 106 may convert the capabilities and supplemental information to the confidence level system.

The autonomous vehicle 102 may communicate a delivery task request to the cloud-based database management unit 106. The kiosk station 104 may receive the task request for accepting a payload from the cloud-based database management unit 106. This task request may include confidence level information in the binary format.

The kiosk station 104 may distribute to the cloud-based database management unit 106 its ability to receive a package based on its analysis of the task request and the kiosk station's capabilities. This distribution may be in a binary format accompanied with any other details such as the location coordinates of the kiosk station 104.

The kiosk station 104 may determine to accept or decline the package delivery based on its confidence level findings. Such determination may be distributed to the cloud-based database management unit 106. The autonomous vehicle may receive such determination from the cloud-based database management unit 106, and plan the package delivery accordingly. Via the mesh network 100, the autonomous vehicle 102, the kiosk station 104, and the cloud-based database management unit 106 can transmit, receive, and relay messages between themselves as necessary.

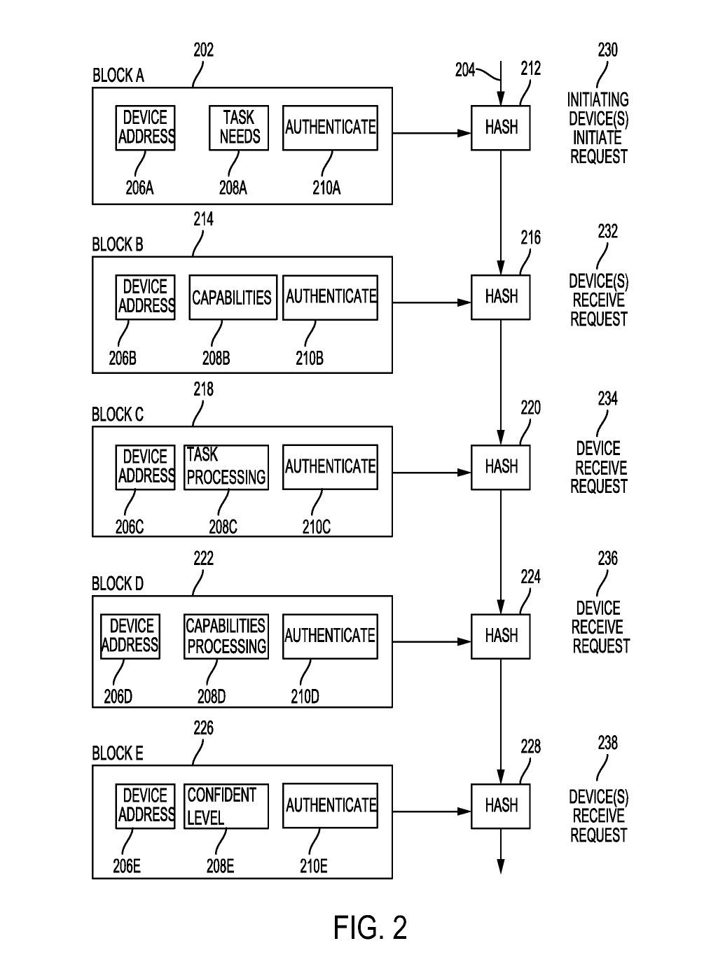

FIG. 2 illustrates an exemplary blockchain based on interactions between the autonomous vehicle 102, the kiosk station 104, and the cloud-based database management unit 106. A blockchain is a distributed digital ledger which is communicated electronically between devices. Each transaction recorded within the digital ledger is a block which can be hashed or otherwise encrypted. As new transactions are added to the digital ledger, each transaction's veracity can be tested against the previous ledger stored by the devices, and can, in some configurations, require confirmation from a defined percentage (usually 50%) of the devices to be added to the blockchain.

In the case where a kiosk station is employed to accept or decline a package delivery from an UAV based on a confidence level system that is converted into binary codes for seamless communication between the kiosk and the UAV, the blockchain can take the form illustrated in FIG. 2. In this example, there is a blockchain 204 which has been distributed among multiple devices, such as the autonomous vehicle 102 (e.g., UAV), the kiosk station 104, and the cloud-based database management unit 106. One of the devices, an initiating device such as the autonomous vehicle 102, determines to deliver a package to the kiosk station 104, and proceeds to initiate a delivery task request 230. Initiation of the delivery task request, in this example, includes generating a block (Block A 202). In this example, the block 202 added to the block chain contains the autonomous vehicle 102 address 206A or identification of the autonomous vehicle 102 making the delivery task request, or otherwise communicating with the remaining devices in the group of devices. The block 202 can contain the task needs 208A, which can include the specific request for resources, delivery requirements, or actions, etc.

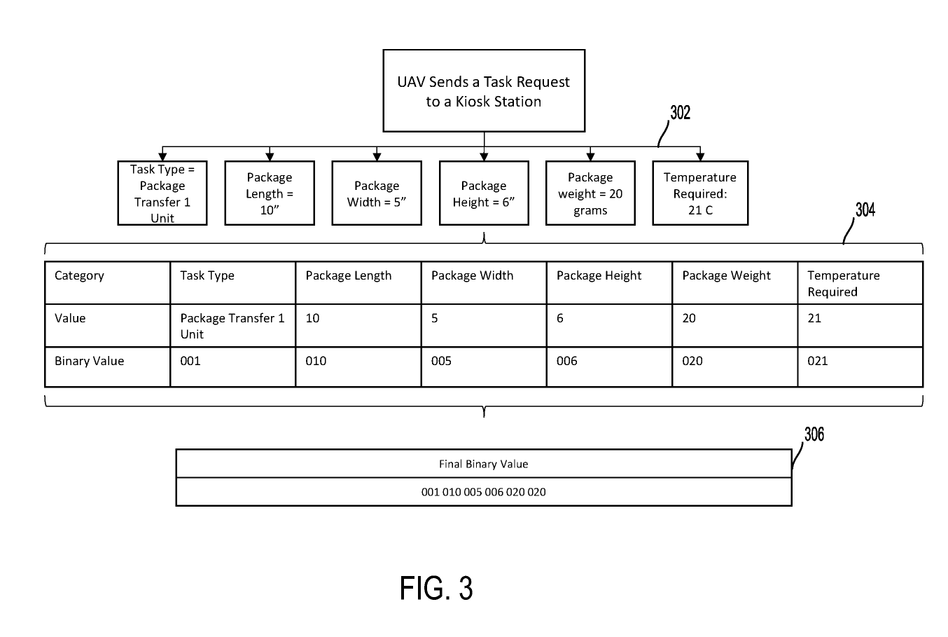

An exemplary specific request 302 is illustrated in FIG. 3. As illustrated in FIG. 3, the specific request 302 may include package transfer unit, package length, package width, package height, package weight, and temperature required. Further, the task needs 208A may include binary values 304 of each respective category of the specific request 302. And a final binary format 306 of the specific request 302 may be also included in the task needs 208A. The final binary format 306 can comprise the binary values 304 of each respective category of the specific request 302. The final binary format 306 may also include binary values of supplemental information or requirements for the delivery task request, such as an age limit for liquor package (e.g., a customer must be over 21 year old for receiving a package containing liquor). In addition, the block 202 can contain an authentication 210A portion, where the device can approve or authenticate the validity of other transactions and provide authority for the present transaction.

As the autonomous vehicle 102 generates the block 202 for the initial delivery task request, the block 202 is hashed 212 into the previous blockchain 204, resulting in an updated blockchain which is distributed among the autonomous vehicle 102, the kiosk station 104, and the cloud-based database management unit 106 in the group. The other devices receive the updated blockchain containing the request 232 and generate block 214 in response to the request. These responses are hashed 216 into the blockchain.

The block 214 may be generated by the kiosk 104. The block 214 added to the block chain can contain the kiosk address 206B or identification of the kiosk 104 making the response to the delivery task request, or otherwise communicating with the remaining devices in the group of devices. The block 214 can contain the capabilities 208B, which can include the specific capabilities of the kiosk 104 for accepting a package. The capabilities 208B may also include actions for handling the package such as printing a label for the package, etc.

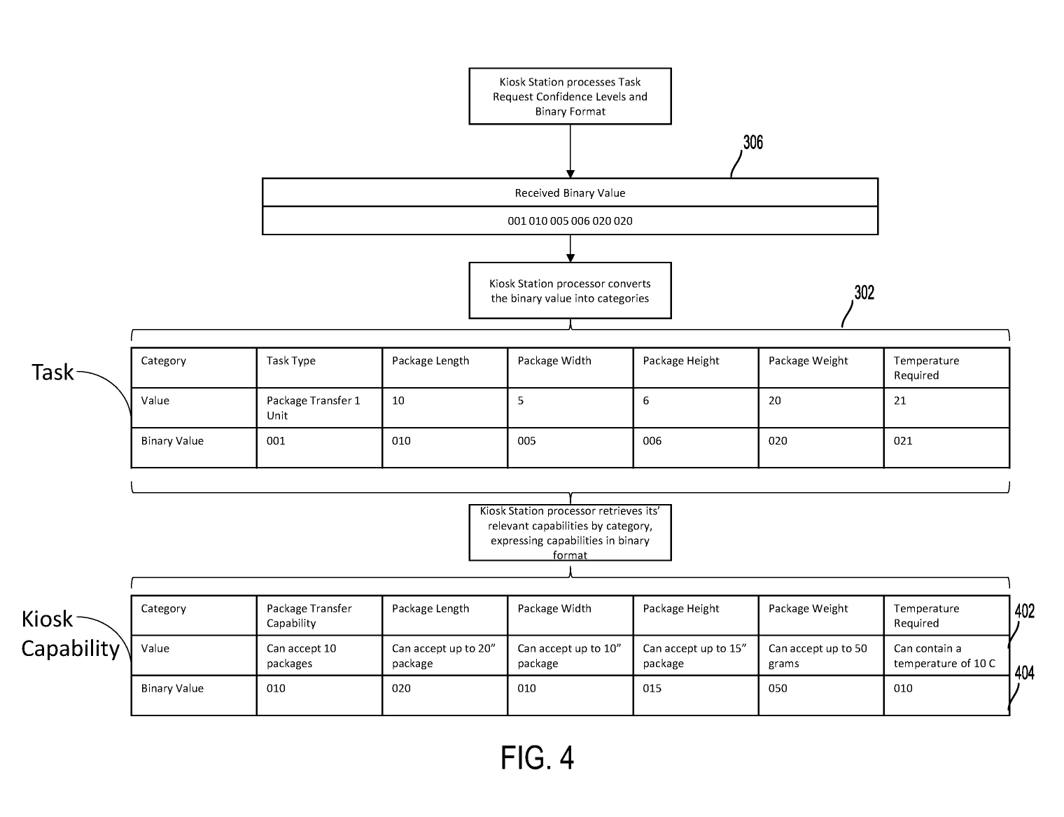

An exemplary specific capabilities 402 is illustrated in FIG. 4. As illustrated in FIG. 4, upon receiving the binary format 306 of the specific request 302, the kiosk 104 may convert the binary values back to corresponding categories of the specific request 302. The kiosk 104 may retrieve relevant capabilities by categories corresponding to the categories of the specific request 302. The capabilities 402 may include the maximum number of packages that can be accepted (e.g., “can accept 10 packages”), length of package that can be accepted (e.g., “can accept up to 20 inch long package”), width of package that can be accepted (e.g., “can accept up to 10 inch wide package”), height of package that can be accepted (e.g., “can accept up to 15 inch high package”), weight of package that can be accepted (e.g., “can accept up to 50 grams”), and a temperature that can provide (e.g., “can contain a temperature of 10 Celsius degrees). The capabilities 402 may also include supplemental capabilities corresponding to the supplemental requirement of the specific request 302. Binary values 404 of each respective category of the capabilities 402 may be generated and stored in the capabilities 208B of the block 214. In addition, a final binary format of the capabilities 402 including the binary values 404 may be also generated and included in the capabilities 208B of the block 214. The final binary format of the capabilities 402 may also include binary values of supplemental information or requirements for accepting the delivery task request, such as an age limit for liquor package (e.g., a customer must be over 21 year old for receiving a package containing liquor). In addition, the block 214 can contain an authentication 210B portion, where the kiosk 104 can approve or authenticate the validity of other transactions and/or provide authority for the present transaction.

In some embodiments, the binary values 304 of each respective category of the specific request 302 may be generated by the cloud-based database management unit 106 as a device receive request 234, and may be stored in a block 218 created by the cloud-based database management unit 106. The block 218 may be subsequently hashed 220 and added to the blockchain. The block 218 added to the blockchain can contain the address 206C or identification of the cloud-based database management unit 106 making the response to the delivery task request, or otherwise communicating with the remaining devices in the group of devices. In such scenario, the task needs 208A may not include the binary values 304 of each respective category of the specific request 302. And the final binary format 306 of the specific request 302 may not be included in the task needs 208A. The binary values 304 and the final binary format 306 may instead be stored in the task processing 208C of the block 218. Again, the final binary format 306 can comprise the binary values 304 of each respective category of the specific request 302. The final binary format 306 may also include binary values of supplemental information or requirements for the delivery task request, such as an age limit for liquor package (e.g., a customer must be over 21 year old for receiving a package containing liquor). In addition, the block 218 can contain an authentication 210C portion, where the cloud-based database management unit 106 can approve or authenticate the validity of other transactions and provide authority for the present transaction.

In some embodiments, the binary values 404 of each respective category of the capabilities 402 are similar as the binary values 304 of each respective category of the specific request 302. Description of the binary values 404 and related actions can be referred to the binary values of 304 as described above.

The final binary format of the specific request 302 may be compared with the final binary format of the capabilities 402 to generate a confidence level. The confidence level may be generated by the cloud-based database management unit 106 as a device receive request 238, and may be stored in a block 226 created by the cloud-based database management unit 106. The block 226 may be subsequently hashed 228 and added to the blockchain. The block 226 added to the blockchain can contain the cloud-based database management unit 106 address 206E or identification of the cloud-based database management unit 106 making the response to the delivery task request, or otherwise communicating with the remaining devices in the group of devices.

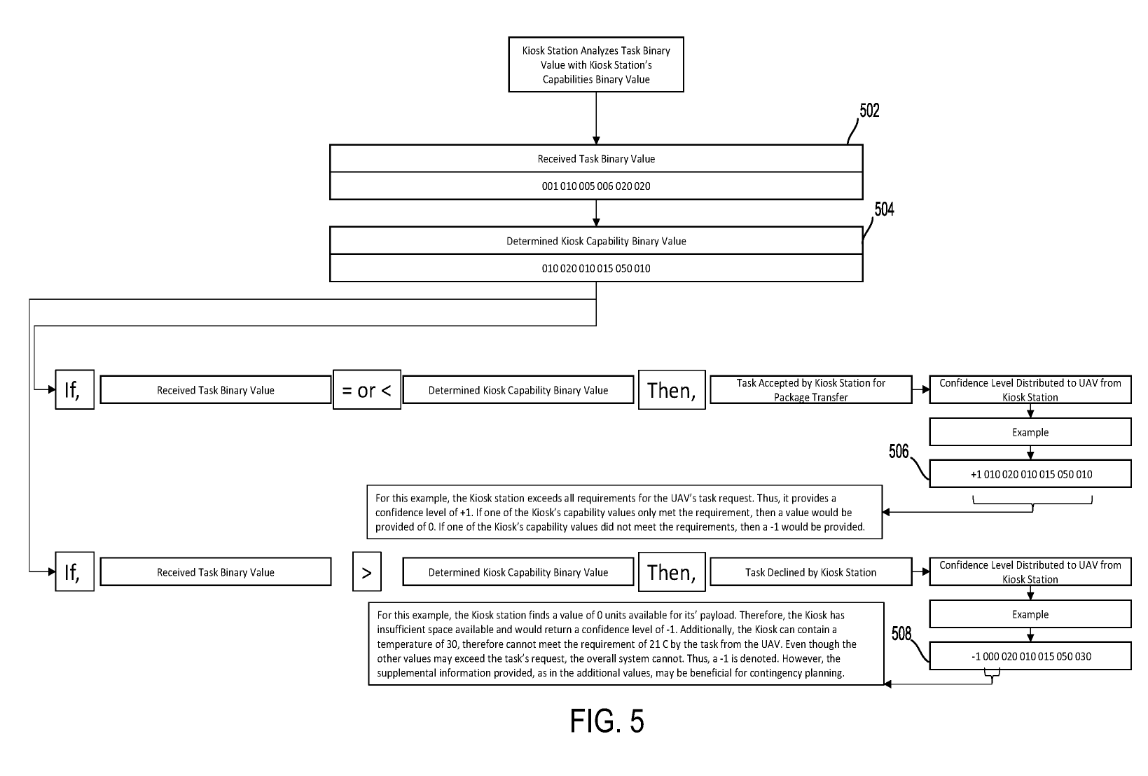

In this example, the confidence level is generated by comparing a binary value of each category of the capabilities 402 in the binary format of the capabilities 402 with a binary value of each corresponding category of the task delivery request 302 in the binary format of the task delivery request 302. FIG. 5 illustrates an exemplary process for generating a confidence level. As shown in FIG. 5, a binary format of task request 502 is compared with a binary format of capabilities 504. The confidence level may be indicated as one of the following: a positive number, when the binary value of the each category of the capabilities of the kiosk station is greater than the binary value of the each corresponding category of the task delivery request; a zero number, when the binary value of at least one category of the capabilities of the kiosk station equals to the binary value of a corresponding category of the task delivery request; and a negative number, when the binary value of at least one category of the capabilities of the kiosk station is less than the binary value of a corresponding category of the task delivery request.

For example, a +1 confidence level 506 is generated when each binary value of the capabilities 504 of the kiosk station is greater than each corresponding binary value of the task delivery request 502, indicating that the kiosk is capable of accepting the package delivery. A −1 confidence level 508 is generated indicating that the kiosk is not capable of accepting the package delivery. When the binary value of at least one category of the capabilities 504 of the kiosk station is less than the binary value of a corresponding category of the task delivery request 502, it indicates that the kiosk is not capable of accepting the package delivery. The resultant confidence levels can be stored in the confidence level 208E of the block 226. In addition, the block 226 can contain an authentication 210E portion, where the cloud-based database management unit 106 can approve or authenticate the validity of other transactions and provide authority for the present transaction.

In some embodiments, the confidence level may be generated by the kiosk 104 or by the autonomous vehicle 102. In some scenarios, an additional block could be generated by the autonomous vehicle 102 to indicate what action will be taken based on the responses received, which is subsequently hashed and added to the blockchain.

In addition, the capabilities of the kiosk 104 may be dynamically updated. For example, a customer may change his or her preferred time for picking up a package, or a children or pet appears in the proximity of the kiosk 104, making UAV delivery undesirable. The kiosk 104 may generate a block reflecting the updated capabilities, which is subsequently hashed and added to the blockchain. Similarly, the task request of the autonomous vehicle 102 may be dynamically updated. For example, the autonomous vehicle 102 may delay the package delivery due to weather. The autonomous vehicle 102 may generate a block reflecting the updated task request, which can similarly be hashed and added to the blockchain. Once the package is delivered, the autonomous vehicle 102 or the kiosk 104 may generate a notification indicating the task request has been fulfilled, which would similarly require a block to be generated and hashed into the blockchain.

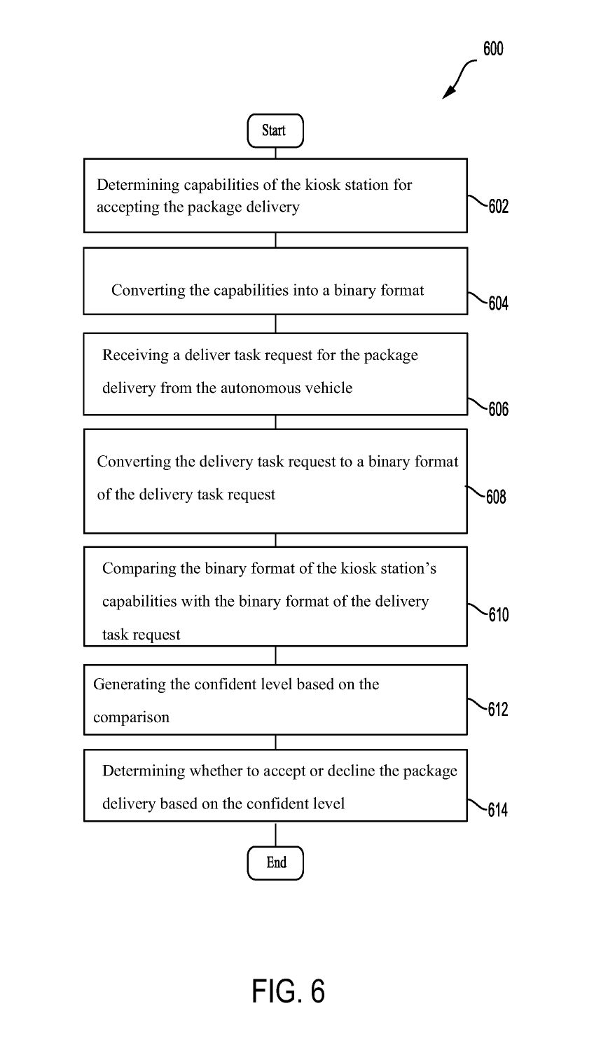

Methods that can be implemented in the above-described systems are also provided in this disclosure. FIG. 6 illustrates an exemplary method embodiment 600 which can be performed by a computing device, such a smart device, server, or any other computing device configured to perform according to the concepts disclosed herein. The method 600 can be provided for a kiosk station to accept or decline a package delivery from an autonomous vehicle based on a confidence level, and may include the following steps.

In step 602, capabilities of the kiosk station for accepting the package delivery is determined. As described, the capabilities are based on different categories of capabilities. The different categories may include, but are not limited to: the maximum number of packages that the kiosk station can accept, package height, package length, package width, and package weight that can be accepted. The different categories may also include a temperature condition the kiosk can provide, an age limit for accepting the package delivery, a time range for accepting the package delivery, and no external object appearing within a proximity of the kiosk station during the package delivery. Further the capabilities for accepting a package may vary for different delivery task requests from the autonomous vehicle.

In step 604, the capabilities are converted into a binary format. The binary format can be made of binary values corresponding to respective different categories of the capabilities. The binary format can further include supplemental binary values corresponding to supplemental capabilities of the kiosk station.

In step 606, a delivery task request for the package delivery from the autonomous vehicle is received. As described, the delivery task request may include requirements for the package delivery. The requirements may include, but are not limited to, the number of packages to be delivered (i.e., transfer unit of package), length of the package, width of the package, weight of the package, height of the package, and a temperature range for storing the package. The requirements may also include special handling of the package or supplemental information. For example, a customer who retrieves the package is required to verify his or her age if the package contain liquors; the package cannot be delivered if a children or pet is in the delivery area of the kiosk station; and/or the package will be delivered no matter whether the customer comes to pick up the package, or a delayed or rescheduled delivery time is required if the package is unable to deliver as scheduled (e.g., due to weather or the customer changes his or her pickup schedule).

In step 608, the delivery task request is converted to a binary format of the delivery task request. The binary format includes binary values of respective categories of the requirements.

In step 610, the binary format of the kiosk station's capabilities is compared with the binary format of the delivery task request. A binary value of each category in the binary format of the capabilities of the kiosk station is compared with a binary value of each corresponding category of the task delivery request in the binary format of the task delivery request. Herein the comparison may include various computational comparison approaches such as individual comparison, summation, median, critical threshold, and/or other statistical approaches.

In step 612, the confidence level is generated based on the comparison. The confidence level can be designated as one of the following: a positive number, when the binary value of each category of the capabilities of the kiosk station is greater than the binary value of each corresponding category of the task delivery request; a zero number, when the binary value of at least one category of the capabilities of the kiosk station equals to the binary value of a corresponding category of the task delivery request; and a negative number, when the binary value of at least one category of the capabilities of the kiosk station is less than the binary value of a corresponding category of the task delivery request.

In step 614, whether to accept or decline the package delivery is determined based on the confidence level. For example, if capabilities values of the kiosk station exceed all requirements for the autonomous vehicle's task request, a confidence level of +1 may be provided to indicate that the kiosk is able to accept the package and the autonomous vehicle will deliver the package accordingly. If one of the kiosk's capability values only meets one corresponding value of the delivery requirement, then a confidence level of value 0 may be provided to indicate that the kiosk may be able to accept the package and the autonomous vehicle may deliver the package accordingly. If one of the kiosk's capability values does not meet one corresponding value of the requirements, then a confidence level of value −1 may be provided to indicate that the kiosk is unable to accept the package and the autonomous vehicle will not deliver the package accordingly.

In some embodiments, the kiosk may also determine whether to accept the package delivery when at least one of the supplemental capabilities cannot meet a corresponding supplemental requirement of the task delivery request. And the autonomous vehicle may or may not complete the package delivery when at least one of the supplemental capabilities cannot meet the corresponding supplemental requirement of the task delivery request. For example, when the kiosk station finds a value of 0 units available for its' payload, the kiosk has insufficient space available and may return a confidence level of −1. Another example, the kiosk can contain a temperature of 30 Celsius degree with an ice pack, and cannot meet the requirement of 20 Celsius degree required by the task request. In such cases, even though the other capabilities values may exceed the corresponding values of the task request, the overall system cannot. Thus, the kiosk may determine not to accept the package delivery, and the autonomous vehicle may not complete the package delivery accordingly. However, the supplemental information provided, as in the additional values in the binary format, may be beneficial for contingency planning. For example, the package delivery may be delayed for a certain amount of time, or be rescheduled for another delivery time. That is, the disclosed systems and methods are able to handle pre-planned package deliveries and exceptional package deliveries as well.

The confidence level can allow the disclosed system to choose between a set of viable options by providing distinctions between the set of options, thus optimizing choices of the disclosed system. For example, two or more places (e.g., two kiosks) could be used to receive package deliveries, or two or more periods of time could be used to have the packages delivered. Then the disclosed system and method can make an optimal choice using a confidence level that is based on a set of observable factors. Some of the set of options may have a threshold, depending on safety, value, quality, etc. If the confidence level does not meet that threshold, then that option should not be selected. That is, the system may not have enough confidence with that option, so the system may choose to cancel or reschedule package deliveries, or make some other choice.

A confidence level may be cumulative sufficiently for a kiosk to receive packages or for an autonomous vehicle to deliver packages. The confidence level may first be based on some of the basic categories in terms of space, weight, safety, temperature, etc. which may define a minimum confidence level in those areas. With more data and information, the confidence level may go up.

A confidence level system may be based on a cumulative score or a categorized score. A set of factors may represent capacity category of a kiosk, for example, package length, package width, package weight, and temperature. For each capacity category that meets or exceeds criteria of corresponding category of package delivery requirement, a higher confidence level may be assigned to that capacity category. Accordingly, for each capacity category that does not meet criteria of corresponding category of package delivery requirement, a lower confidence level may be assigned to that capacity category. A determination of whether the kiosk accepts package deliveries or the UAV delivers the packages to this kiosk may be based on a cumulative score of the confidence level of each capacity category or a categorized score of each category confidence level. For example, the cumulative score can be a sum of all the confidence levels of all the capacity categories; the categorized score can be a confidence level of each capacity category.

In some embodiments, the confidence level may be dynamic. For example, the disclosed system may not have enough information of a kiosk. The confidence level for that kiosk may be reduced from a higher level to a lower level with time passing. As another example, dynamics of the confidence level may also consider the performance of given customers to actually retrieve their packages in a timely manner versus holding a slot for an excessive time, for example. That is, a customer may pick up their packages in a timely manner, rather than have the packages remain in a kiosk for an excessive time. In such case, that kiosk can be assigned a higher confidence level. Further, dynamics of the confidence level may consider other data or task with missing data.

In some embodiments, there may have extra factors that determine whether a UAV will deliver packages to a kiosk. For example, a customer's preference may be a factor. When a customer is closer to a first kiosk than a second kiosk, and the customer also tends to pick up his packages timely, then first kiosk may be assigned a higher confidence level than the second kiosk. The reasoning is: not only is the package preferred to be delivered as soon as possible, but the package is also preferred to store in a slot of a kiosk for as short a time as can, so that slot can be opened up for another package sooner once the package is picked up by the customer. Safety may also be a factor. For example, if there are children or adults present near a kiosk prior to a package delivery, the confidence level of that kiosk may get reduced. The UAV may wait for an additional period of time and check again prior to delivery, as long as the UAV has sufficient battery power to stay in the air and continues operating. When the battery of the UAV starts to get into a marginal area, the confidence level of that kiosk may be further reduced to be acceptable but not a high degree of confidence. Depending on a business threshold, the UAV may cancel or reschedule the package delivery, or choose another kiosk to deliver the package. For example, the business threshold may not allow the UAV to continue to wait if the confidence level of the kiosk is barely in an acceptable zone, as opposed to in a high confidence zone, due to the risk of running out of power. With the reduced confidence level of the kiosk, the UAV may not be able to commit to delivering in the next time interval, because the UAV does not know if the children are going to be clear at that time. So, the business threshold may determine that the confidence level of the kiosk is insufficient to continue waiting, because the other obstacles are not clear.

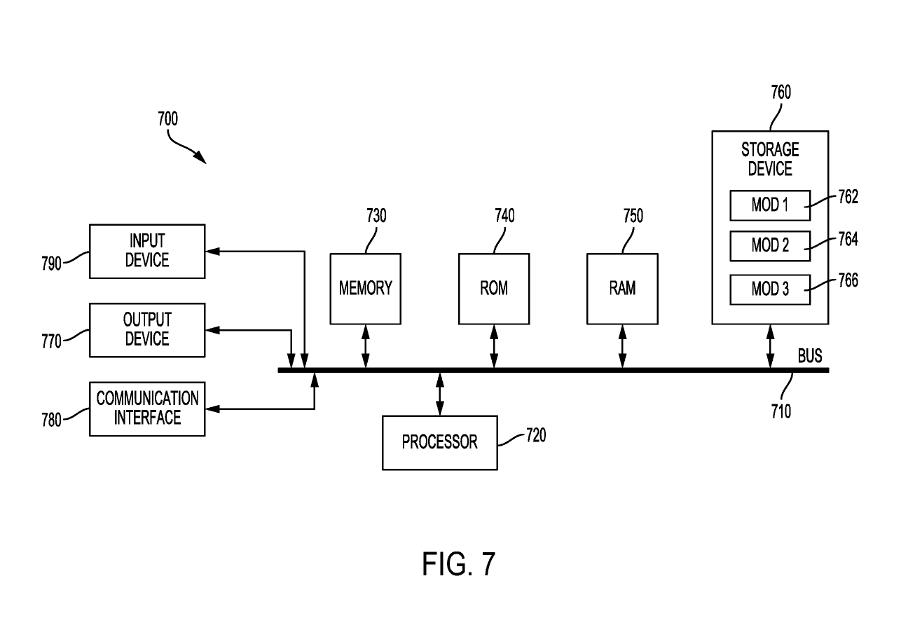

An exemplary computing system is provided in FIG. 7 that may be used to implement or part of the disclosed systems and methods. With reference to FIG. 7, an exemplary system 700 can include a processing unit (CPU or processor) 720 and a system bus 710 that couples various system components including the system memory 730 such as read only memory (ROM) 740 and random access memory (RAM) 750 to the processor 720. The system 700 can include a cache of high speed memory connected directly with, in close proximity to, or integrated as part of the processor 720. The system 700 copies data from the memory 730 and/or the storage device 760 to the cache for quick access by the processor 720. In this way, the cache provides a performance boost that avoids processor 720 delays while waiting for data. These and other modules can control or be configured to control the processor 720 to perform various actions. Other system memory 730 may be available for use as well. The memory 730 can include multiple different types of memory with different performance characteristics. It can be appreciated that the disclosure may operate on a computing device 700 with more than one processor 720 or on a group or cluster of computing devices networked together to provide greater processing capability. The processor 720 can include any general purpose processor and a hardware module or software module, such as module 1 762, module 2 764, and module 3 766 stored in storage device 760, configured to control the processor 720 as well as a special-purpose processor where software instructions are incorporated into the actual processor design. The processor 720 may essentially be a completely self-contained computing system, containing multiple cores or processors, a bus, memory controller, cache, etc. A multi-core processor may be symmetric or asymmetric.

The system bus 710 may be any of several types of bus structures including a memory bus or memory controller, a peripheral bus, and a local bus using any of a variety of bus architectures. A basic input/output (BIOS) stored in ROM 740 or the like, may provide the basic routine that helps to transfer information between elements within the computing device 700, such as during start-up. The computing device 700 further includes storage devices 760 such as a hard disk drive, a magnetic disk drive, an optical disk drive, tape drive or the like. The storage device 760 can include software modules 762, 764, 766 for controlling the processor 720. Other hardware or software modules are contemplated. The storage device 760 is connected to the system bus 710 by a drive interface. The drives and the associated computer-readable storage media provide nonvolatile storage of computer-readable instructions, data structures, program modules and other data for the computing device 700. In one aspect, a hardware module that performs a particular function includes the software component stored in a tangible computer-readable storage medium in connection with the necessary hardware components, such as the processor 720, bus 710, display 770, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 700 is a small, handheld computing device, a desktop computer, or a computer server.

Although the exemplary embodiment described herein employs the hard disk 760, other types of computer-readable media which can store data that are accessible by a computer, such as magnetic cassettes, flash memory cards, digital versatile disks, cartridges, random access memories (RAMs) 750, and read only memory (ROM) 740, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 700, an input device 790 represents any number of input mechanisms, such as a microphone for speech, a touch-sensitive screen for gesture or graphical input, keyboard, mouse, motion input, speech and so forth. An output device 770 can also be one or more of a number of output mechanisms known to those of skill in the art. In some instances, multimodal systems enable a user to provide multiple types of input to communicate with the computing device 700. The communications interface 780 generally governs and manages the user input and system output. There is no restriction on operating on any particular hardware arrangement and therefore the basic features here may easily be substituted for improved hardware or firmware arrangements as they are developed.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A system for a kiosk station to autonomously accept or decline a package delivery from an autonomous vehicle based on a confidence level, comprising:
the kiosk station configured to:
determine its capabilities for accepting the package delivery;
convert the capabilities into a binary format; and
transmit the binary format to a cloud-based database management unit,
the autonomous vehicle configured to:
generate a delivery task request for the package delivery to be sent to the kiosk station;
convert the delivery task request to a binary format; and
transmit the binary format to the cloud-based database management unit, and
the cloud-based database management unit configured to:
compare the binary format of the kiosk station's capabilities with the binary format of the delivery task request;
generate the confidence level based on the comparison; and
distribute the confidence level to the kiosk station and the autonomous vehicle wherein:
the kiosk is further configured to determine whether to accept or decline the package delivery based on the confidence level; and
the autonomous vehicle is further configured to determine whether to perform the package delivery based on the confidence level.

2. The system of claim 1, wherein:
the capabilities of the kiosk station are based on different categories of the capabilities; and
the binary format of the capabilities includes binary values corresponding to respective different categories.

3. The system of claim 2, wherein the different categories include at least one of: the maximum number of packages that the kiosk station can accept, package height, package length, package width, and package weight.

4. The system of claim 2, wherein the different categories include at least one of: a temperature condition the kiosk can provide, an age limit for accepting the package delivery, a time range for accepting the package delivery, and no external object appearing within a proximity of the kiosk station during the package delivery.

5. The system of claim 2, wherein the confidence level is a cumulative score based on scores of each of the different categories.

6. The system of claim 1, wherein the delivery task request includes requirements for the package to be delivered, the requirements including at least one of: the number of package to be delivered, length of the package, width of the package, weight of the package, height of the package, and a temperature range for storing the package.

7. The system of claim 1, wherein the confidence level is generated by comparing a binary value of each category of the capabilities in the binary format of the capabilities of the kiosk station with a binary value of each corresponding category of the task delivery request in the binary format of the task delivery request.

8. The system of claim 7, wherein the confidence level is indicated as one of the following:
a positive number, when the binary value of the each category of the capabilities of the kiosk station is greater than the binary value of the each corresponding category of the task delivery request;
a zero number, when the binary value of at least one category of the capabilities of the kiosk station equals to the binary value of a corresponding category of the task delivery request; and
a negative number, when the binary value of at least one category of the capabilities of the kiosk station is less than the binary value of a corresponding category of the task delivery request.

9. The system of claim 8, wherein:
the kiosk is further configured to accept the package delivery when the confidence level is the positive number or the zero number; and
the autonomous vehicle is further configured to perform the package delivery when the confidence level is the positive number or the zero number.

10. The system of claim 8, wherein:
the kiosk is further configured to decline the package delivery when the confidence level is the negative number; and
the autonomous vehicle is further configured not to perform the package delivery when the confidence level is the negative number.

11. The system of claim 7, wherein:
the binary format of the capabilities of the kiosk station further includes supplemental binary values corresponding to supplemental capabilities of the kiosk station; and
the kiosk is further configured not to accept the package delivery when at least one of the supplemental capabilities cannot meet a corresponding supplemental requirement of the task delivery request; and
the autonomous vehicle is further configured to not complete the package delivery when at least one of the supplemental capabilities cannot meet the corresponding supplemental requirement of the task delivery request.

12. The system of claim 1, wherein the cloud-based database management unit is further configured to:
convert the capabilities into the binary format of the capabilities; and
convert the delivery task request to the binary format of the delivery task request.

13. The system of claim 1, wherein the cloud-based database management unit is further configured to communicate location coordinates of the kiosk station to the autonomous vehicle when the kiosk determines to accept the package delivery.

14. The system of claim 1, wherein the cloud-based database management unit is a blockchain management unit.

15. A method for a kiosk station to accept or decline a package delivery from an autonomous vehicle based on a confidence level, comprising:
determining capabilities of the kiosk station for accepting the package delivery;
converting the capabilities into a binary format;
receiving a delivery task request for the package delivery from the autonomous vehicle;
converting the delivery task request to a binary format of the delivery task request;
comparing the binary format of the kiosk station's capabilities with the binary format of the delivery task request;
generating the confidence level based on the comparison; and
determining whether to accept or decline the package delivery based on the confidence level.

16. The method of claim 15, further comprising:
transmitting the binary format of the capabilities to a cloud-based database management unit;
transmitting the binary format of the task delivery request to the cloud-based database management unit; and
distributing the confidence level to the kiosk station and the autonomous vehicle.

17. The method of claim 15, wherein the confidence level is generated by comparing a binary value of each category of the capabilities in the binary format of the capabilities of the kiosk station with a binary value of each corresponding category of the task delivery request in the binary format of the task delivery request.

18. The method of claim 17, wherein the confidence level is indicated as one of the following:
a positive number, when the binary value of the each category of the capabilities of the kiosk station is greater than the binary value of the each corresponding category of the task delivery request;
a zero number, when the binary value of at least one category of the capabilities of the kiosk station equals to the binary value of a corresponding category of the task delivery request; and
a negative number, when the binary value of at least one category of the capabilities of the kiosk station is less than the binary value of a corresponding category of the task delivery request.

19. The method of claim 18, further comprising:
accepting the package delivery when the confidence level is the positive number or the zero number.

20. The method of claim 18, further comprising:
declining the package delivery when the confidence level is the negative number.
